(19) United States
(12) Patent Application Publication
(10) Pub. No.: US 2015/0207759 A1
(43) Pub. Date: Jul. 23, 2015

(54) DISTRIBUTED COMPUTING SYSTEM, CLIENT COMPUTER FOR DISTRIBUTED COMPUTING, SERVER COMPUTER FOR DISTRIBUTED COMPUTING, DISTRIBUTED COMPUTING METHOD, AND INFORMATION STORAGE MEDIUM

(71) Applicant: SONY COMPUTER ENTERTAINMENT INC., TOKYO (JP)

(72) Inventor: Hisashi Tomita, Tokyo (JP)

(73) Assignee: SONY COMPUTER ENTERTAINMENT INC., TOKYO (JP)

(21) Appl. No.: 14/416,816

(22) PCT Filed: May 23, 2013
(86) PCT No.: PCT/JP2013/064377

§ 371 Date: Jan. 23, 2015

(30) Foreign Application Priority Data
Aug. 30, 2012 (JP) 2012-190570

(51) Int. Cl. H04L 12/927; G06F 1/26; H04L 29/08

(52) U.S. Cl. CPC H04L 47/80; H04L 67/1097; G06F 1/266

(57) ABSTRACT

A distributed computing system is provided that is configured to allocate more non-use time of each client computer to distributed computing. This distributed computing system includes a server computer and a plurality of client computers. Each of the plurality of client computers has a schedule data storage block (20) configured to store schedule data indicative of a time at which the client computer participates in distributed computing; a control block (22) configured to request the server computer for data related with distributed computing in accordance with the schedule data; and a program execution block (20) configured to receive data transmitted in accordance with the request and execute information processing related with the distributed computing on the basis of the received data.

### TECHNICAL FIELD

The present invention relates to a distributed computing system, a client computer for distributed computing, a server computer for distributed computing, a distributed computing method, and an information storage medium.

### BACKGROUND ART

In distributed computing, partial programs are executed by many client computers, the results of execution of these programs are collected by a server computer, and a target result is obtained from these collected results. For these client computers that carry out the distributed computing described above, computers not dedicated to the distributed computing, such as personal computers and game machines, are sometimes used. In such a case, partial programs related with the distributed computing are executed while these computers are not used for other use purposes such as web browsing and gaming (namely, an unused period).

### CITATION LIST

### Patent Literature

### [PLT 1]

Japanese Patent Laid-Open No. 2008-102857

### SUMMARY

### Technical Problem

It is difficult to grasp the unused period (a period in which each client computer can participate in a distributed computing) of each client computer at the server computer side. Therefore, in a prior-art computing system, the user of each client computer starts up a management program for distributed computing in a period in which the user himself does not use the client computer for other purposes, transmits the display of intention to participate in distributed computing to the server computer, and downloads and executes a partial program related with the distributed computing. This causes a problem that, of the period in which each client computer is not used for other purposes, only a part thereof is actually allocated to the distributed computer.

The present invention has been made in consideration with the problem described above, an object of the present invention being to provide a distributed computing system, a client computer for distributed computing, a server computing for distributed computing, a distribute computing method, and an information storage medium that are configured to allocate a period in which each client computer is not used to distributed computing more.

### Solution to Problem

In carrying out the invention to solve the problem, there is provided a distributed computing system including a server computer and two or more client computers. Each of these client computers has: schedule data storage means for storing schedule data indicative of a time at which the client computer participates in distributed computing; request means for requesting the server computer for data related with distributed computing in accordance with the schedule data; and information processing means for receiving data transmitted in accordance with the request and executing information processing related with the distributed computing on the basis of the received data.

The above-mentioned each client computer may control a power to the client computer concerned in accordance with the schedule.

The above-mentioned each client computer may transmit the schedule to the server computer.

In receiving the request from the each client computer, if there is no information processing related with the distributed computing to be executed in the client computer, the abovementioned server computer may transmit, to the client computer, data indicative of date at which the client computer next transmits the request to the server computer on the basis of the schedule data.

The above-mentioned server computer may store a point value in accordance with a time of the information processing in the each client computer by relating the point value with this client computer.

In carrying out the invention, there is provided a client computer for distributed computing. This client computer has: schedule data storage means for storing schedule data indicative of a time at which the client computer participates in distributed computing; request means for requesting the server computer for data related with distributed computing in accordance with the schedule data; and information processing means for receiving data transmitted in accordance with the request and executing information processing related with the distributed computing on the basis of the received data.

In carrying out the invention, there is provided a server computer for distributed computing. This server computer has: schedule data reception means for receiving, from a plurality of client computers for distributed computing, schedule data indicative of a time at which the client computer participates in distributed computing; request reception means for receiving a request transmitted by the each client computer on the basis of the schedule data; and data transmission means for, in receiving the request from the each client computer, if there is no information processing related with the distributed computing to be executed in the client computer, transmitting, to the client computer, data indicative of a date on which the client computer next transmits the request on the basis of the each piece of schedule data.

In carrying out the invention, there is provided a distributed computing method. This method has: a step of setting schedule data indicative of a time at which participation in distributed computing is done; a step of requesting a server computer for data related with distributed computing in accordance with the schedule data; and a step of receiving data transmitted in accordance with the request in order to execute information processing related with the distributed computing on the basis of the received data.

In carrying out the invention, there is provided a program. This program causes a computer to function as: schedule data storage means for storing schedule data indicative of a time at which participation in distributed computing is done; request means for requesting the server computer for data related with distributed computing in accordance with the schedule data; and information processing means for receiving data transmitted in accordance with the request and executing information processing related with the distributed computing on the basis of the received data. This program may be stored in a computer-readable information storage medium such as a CD-ROM or a DVD-ROM.

### BRIEF DESCRIPTION OF DRAWINGS

FIG. 1 is a total configuration diagram illustrating a distributed computing system related with an embodiment of the present invention.

FIG. 2 is a hardware configuration diagram illustrating a client computer.

FIG. 3 is a functional block diagram illustrating a client computer.

FIG. 4 is a functional block diagram illustrating a mediation server.

FIG. 5 is a diagram illustrating a configuration of user data.

FIG. 6 is a diagram illustrating a configuration of distributed computing data.

FIG. 7 is a diagram illustrating a structure of schedule data.

FIG. 8 is a sequence diagram illustrating an operation of the distributed computing system related with the embodiment of the present invention.

FIG. 9 is a diagram illustrating an example of a transition a resource allowance.

FIG. 10 is a diagram illustrating an example of a transition of estimated values of a resource allowance.

FIG. 11 is a diagram illustrating distributed computing data related with a variation.

FIG. 12 is a table listing point values that are allocated to a user per unit participation time in each time zone.

### DESCRIPTION OF EMBODIMENT

The following describes embodiment of the present invention in detail on the basis of drawings.

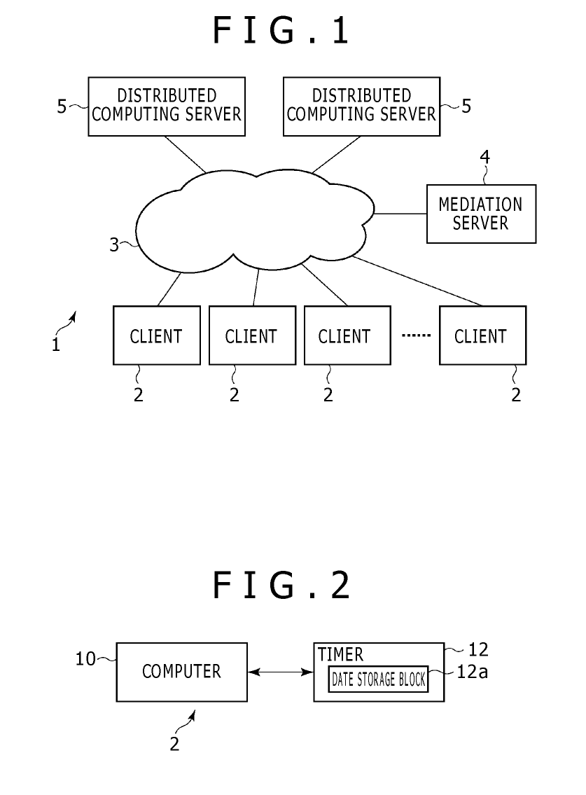

Now, referring to FIG. 1, there is shown an overall configuration diagram illustrating a distributed computing system related with one embodiment of the present invention. A distributed computing system 1 is configured by including a mediation server 4 connected to a data communication network 3 such as the Internet, a plurality of distributed computing servers 5, and a plurality of clients 2. The distributed computing server 5 is a computer that transmits programs and data related with distributed computing to the client 2 in response to a request and receives results of execution at that client 2. The distributed computing server 5 obtains computation results that are a final target on the basis of the execution results received from each client 2. The client 2 is a computer such as a personal computer or a home game machine and, arranged at each home by having web browsing, mail communication, gaming, documentation, spread sheeting, and other use purposes. The mediation server 4 is a computer for mediating the participation of the client 2 into the distributed computing based on the distributed computing server 5. In the present embodiment, each distributed computing server 5 executes distributed computing separate from other clients. On the other hand, on the basis of data transmitted from the any one of distributed computing server 5, each client 2 executes information processing related with the distributed computing that is executed by that distributed computing server 5, by use of a time not used for other purposes such as web browsing.

Referring to FIG. 2, there is shown a hardware configuration diagram of the client 2. As shown in the figure, the client 2 includes a computer 10 configured by arithmetic means such as a CPU and a memory and a timer 12. The timer 12 has a date storage block 12a based on a nonvolatile memory to which given date data can be written from the computer 10. Then, when a date indicated by the date data stored in the date storage block 12a arrives, the timer 12 powers on the computer 10 if the power to the computer 10 is off. It should be noted that the power control executed by the timer 12 is not limited to the above-mentioned example; it is also practicable to switch between a low power dissipation standby state (a so-called suspend state or sleep state) in which power supply to components of the computer 10 excluding the memory is limited and a normal power dissipation state.

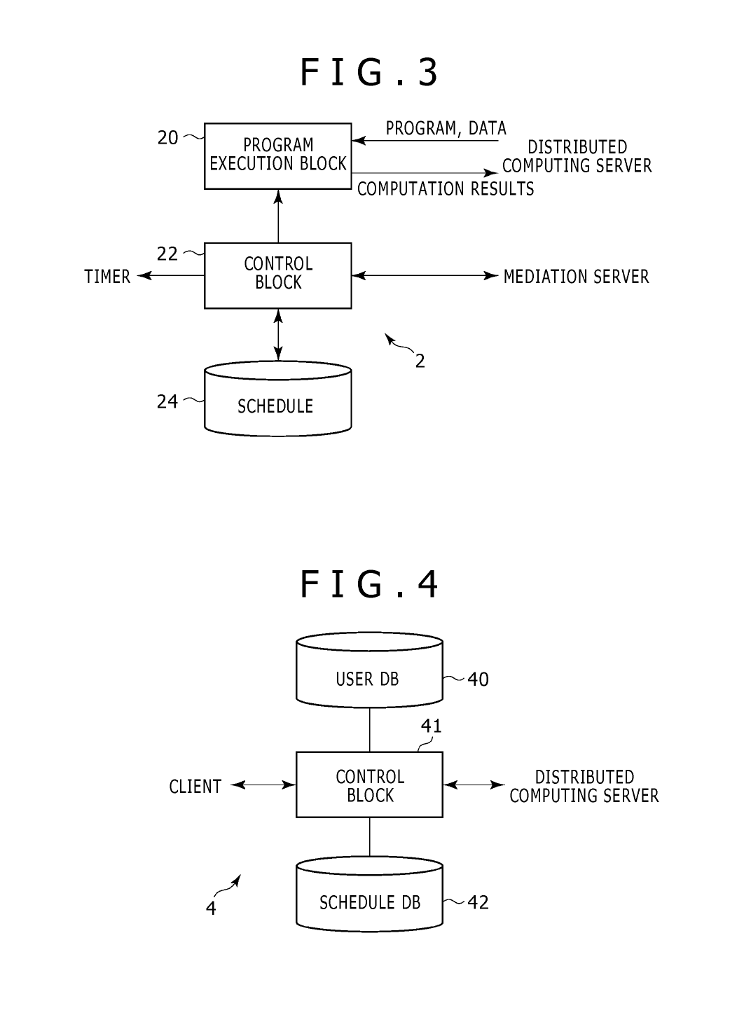

Referring to FIG. 3, there is shown a functional block diagram of the client 2. As shown in the figure, the client 2 functionally includes a program execution block 20, a control block 22, and a schedule storage block 24. These elements are realized by the execution of a program related with the embodiment of the present invention in the computer 10. This program may be downloaded from another computer to the client 2 through the data communication network 3 and installed in the client 2. Alternatively, this program may be stored in a computer-readable information storage medium such as a CD-ROM or a DVD-ROM and the client 2 may read the program from the computer-readable information storage medium and install the program into the client 2.

The program execution block 20 is configured mainly by arithmetic means such as a CPU and communicates with the distributed computing server 5, thereby sharing part of distributed computing. To be more specific, the program execution block 20 receives a program (a partial program), data to be processed by the program, and data related with distributed computing. Then, the program execution block 20 executes information processing on the basis of the received data. The schedule storage block 24 is configured mainly by a nonvolatile semiconductor memory or a hard disk memory device and stores schedule data indicative of a time in which the client 2 can participate in distributed computing, namely, a non-use time of the client 2. The schedule data may be a pair of start date and end date for identifying a non-use time among constant periods subsequent to a current time such as one week or one month or a pair of start date and non-use time continuing time. Alternatively, the schedule data may be one indicative of a condition corresponding to a non-use time such as “from X o'clock to Y o'clock of Z day of every week.”

The control block 22 executes various types of processing operations related with distributed computing. Especially, on the basis of input information by the user through a pointing device such as a mouse and a keyboard, the above-mentioned schedule data is set and this schedule data is stored into the schedule storage block 24. The control block 22 reads the schedule data thus stored and stores the start date of a next non-use time into the date storage block 12a of the timer 12. This allows the power to the client 2 to be turned on at the start date of a next non-use time, thereby allowing participation in the distributed computing. The control block 22 stores UID that is user identification information of the client 2 and the address (IP address) of the data communication network 3 and transmits these items of information to the mediation server 4 at the start of non-use time.

Referring to FIG. 4, there is shown a functional block diagram of the mediation server 4. As shown in the figure, the mediation server 4 functionally includes a user database 40, a control block 41, and a schedule database 42. These elements are also realized by the execution of a program related with the embodiment of the present invention by a server computer constituting the mediation server 4. This program may also be downloaded from another computer to the mediation server 4 through the data communication network 3 and installed. In addition, this program may also be stored in a computer-readable information storage medium such as a CD-ROM or a DVD-ROM and the mediation server 4 may read this program from the computer-readable information storage medium and install the program.

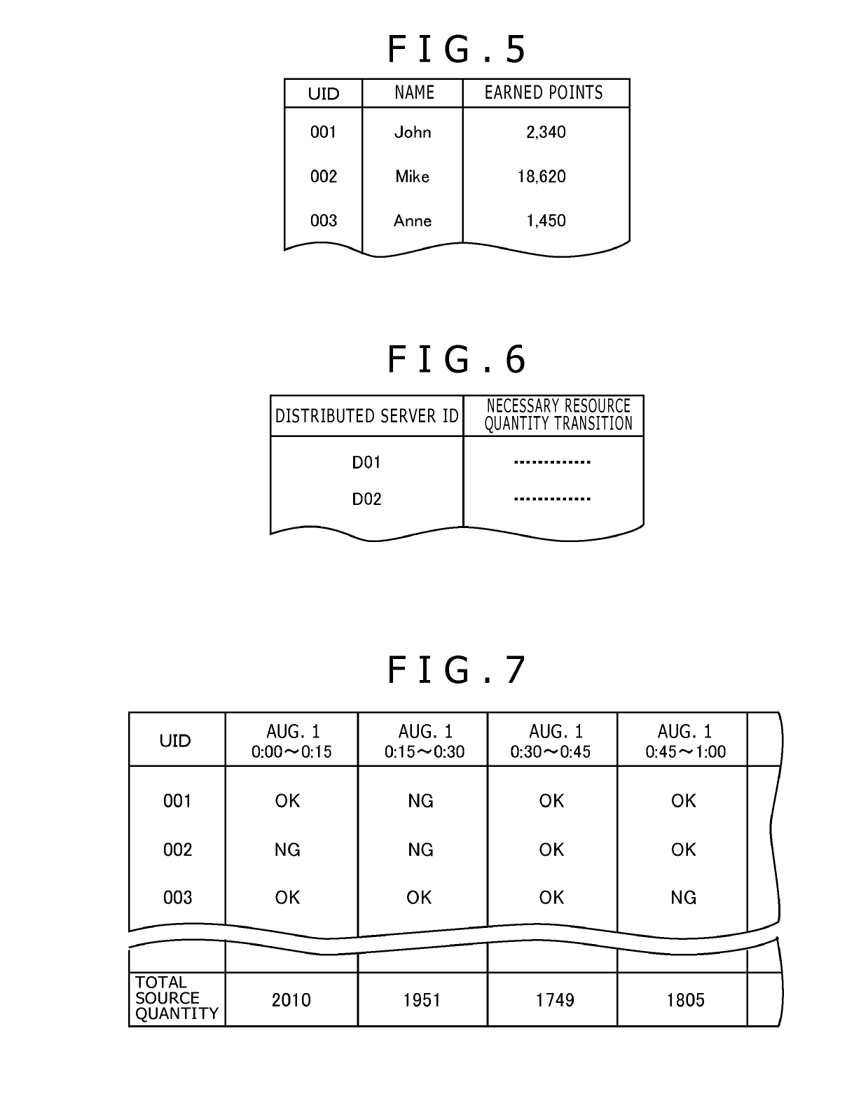

The user database 40 is configured by storage means such as hard disk memory device and stores the UID of the user of the client 2, the name of this user, and a point value already obtained by the user by relating these items of information as shown in FIG. 5. This point value is added in accordance with a time of information processing related with distributed computing by use of the client 2 and may be exchanged with a variety of products and services. This configuration allows the user of the client 2 to be motivated for setting a lot of time to the schedule data as a non-use time, thereby allocating a computation resource enough for the entire distributed computing system 1.

The schedule database 42 is configured by storage means such as a hard disk memory device and stores distributed computing data shown in FIG. 6 as an example and schedule data shown in FIG. 7 as an example. In the distributed computing shown in FIG. 6, the distributed server ID that is the identification information of the distributed computing server 5 is related with a transition of the quantity of a computation resource necessary for the distributed computing being executed on the distributed computing server 5. The quantity of a computation resource may be the number of instructions to be executed in a unit time such as MIPS (million instructions per second) or, if all clients 2 are computers of the same type and same performance, a computation resource may simply be the number of clients 2 for example. Further, schedule data is an accumulation of the schedule data stored in each client 2 and the example of schedule data shown in FIG. 7 includes the UID of the user of the client 2 and the information indicating whether each time zone (every 15 minutes here) subsequent to the current time is a non-use time or not. In addition, schedule data also includes a transition of the quantity of a computation resource available to the entire distributed computing system 1. This can be obtained by counting the clients 2 that set a non-use time in each time zone. Thus, accumulation of the schedule data transmitted from the clients 2 allows the understanding of the availability of the quantities of computation resources for distributed computing beforehand in the mediation server 4.

The control block 41 executes various processing operations related with distributed computing. Especially, schedule data is received from the client 2 and stored in the schedule database 42. Also, after the execution of information processing related with distributed computing by the client 2, processing of adding a point value corresponding to that time is added to a point value already stored in the user database.

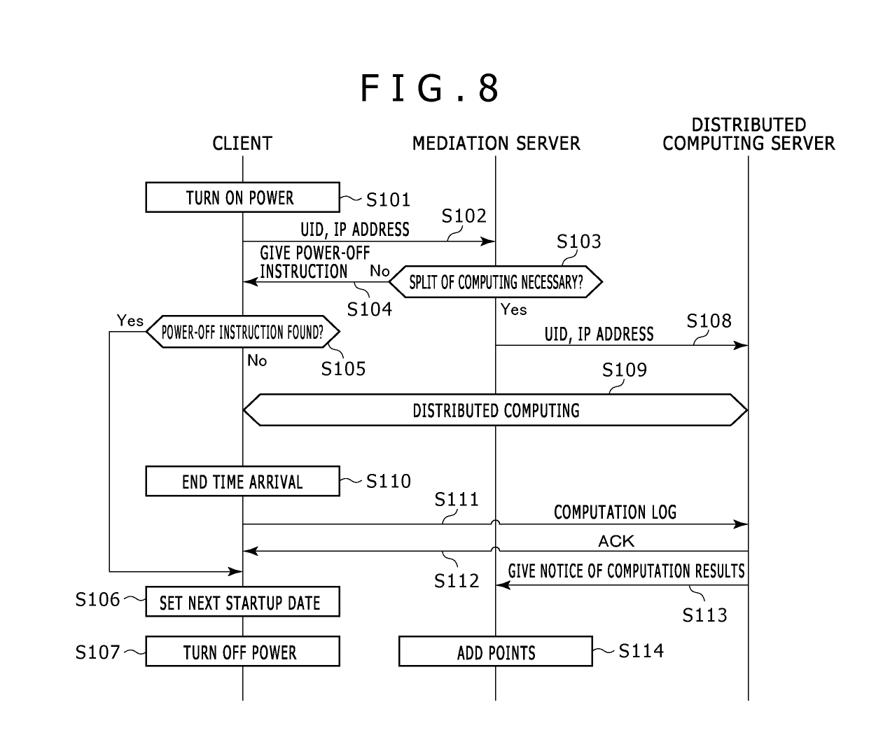

Referring to FIG. 8, there is shown an operation sequence diagram of the distributed computing system 1. As shown in the figure, the timer 12 of the client 2 monitors the arrival of a date stored in the date storage block 12a and, when this date arrives, turns on the power to the client 2 (S101). It should be noted that, if the power has already been turned on by the user himself by executing a power-on sequence for example, then the procedure goes to S102 by skipping S101. Alternatively, if the power is on, the processing operations subsequent to S102 are not executed; instead, schedule data is read from the schedule storage block 24, a start date of a next non-use time is obtained from the schedule data, and the obtained date may be stored in the date storage block 12a of the timer 12. Thus, if the power is already on, it is regarded that the user is using the client 2, thereby discarding the participation in distributed computing.

Next, a request including the UID and IP address of the user of the client 2 is transmitted to the mediation server 4 (S102). On the basis of a necessary computation resource quantity indicated by the distributed computing data stored in the schedule database 42 and the number of clients 2 already currently participating in distributed computing, the mediation server 4 determines whether the split of the distributed computing by the clients 2 is required or not (S103). To be more specific, if the number of clients 2 already currently participating in distributed computing is higher than a necessary computation resource quantity indicated in the distributed computing data (the number of clients 2), split is determined unrequired. If the splitting is found unrequired, then a power-off instruction is issued to the client 2 (S104).

Receiving the power-off instruction (S105), the client 2 reads schedule data from the schedule storage block 24 to obtain the start date of a next non-use time. Then, the obtained date is stored in the date storage block 12a of the timer 12 (S106). It should be noted that the mediation server 4 may transmit the data for identifying a date to be stored in the date storage block 12a (data indicative of date itself or data indicative of elapsed time such as X minutes after) to the client 2 in S104. In this case, the client 2 stores a date identified by the above-mentioned data into the date storage block 12a. For example, on the basis of the schedule data stored in the schedule database, the mediation server 4 can determine a time zone subsequent to the current time at which the computation resource will run short. Then, the data for identifying the start date of that time zone may be transmitted to the client 2.

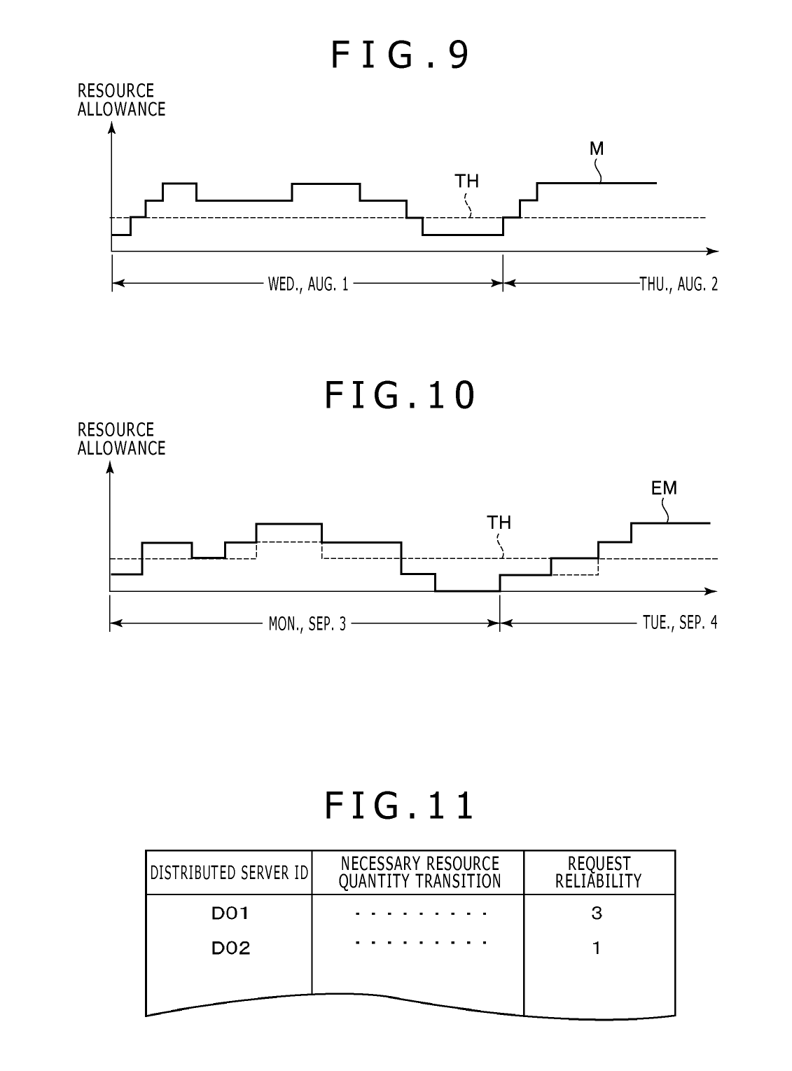

To be more specific, the schedule data (FIG. 7) includes a transition of the quantity of computation resource available to the entire distributed computing system 1. The distributed computing data (FIG. 6) also includes a transition of a computation resource quantity required by each distributed computing server 5. Hence, the mediation server 4 can calculate a value obtained by subtracting a sum of computation resource quantities required by each distributed computing server 5 from a computation resource quantity available to the entire distributed computing system 1, as a resource allowance in each time zone. FIG. 9 shows one example of a transition of this resource allowance. Out of the time zones in which a time zone subsequent to the current time in which this resource allowance M is not higher than threshold TH overlaps a time zone subsequent to the current time set by the user of the client 2 as a non-use time, the mediation server 4 transmits the data for identifying the start date of the time zone nearest to the current time to the client 2. It should be noted that whether or not each user participated in distributed computing exactly in accordance with the schedule data in the past may be recorded and the transition of resource allowance may be corrected in accordance with that record.

Subsequently, in the client 2, the control block 22 turns off the power to the client 2 concerned (S107). It should be noted that, when the date stored in the date storage block 12a arrives and, if the power to the client 2 is already on in S101, then it is preferable not to turn off the power also in S107.

If the split of distributed computing is found required in S103, then the mediation server 4 transfers the UID and IP address received from the client 2 to any of the distributed computing server 5 requiring computation resource (S108). It should be noted that the UID may be transmitted after hashing for the purpose of personal information protection.

Receiving the above-mentioned data, the distributed computing server 5 transmits a program related with distributed computing and data to be processed thereby and other data to the client 2. It should be noted that, instead of accessing from the distributed computing server 5 to the client 2 by transmitting the IP address of the client 2 to the distributed computing server 5 in S108, the client 2 may receive the IP address for identifying the distributed computing server 5 and other data from the mediation server 4 and the client 2 may access the distributed computing server 5. On the basis of the data received from the distributed computing server 5, the client 2 executes information processing in the program execution block 20 and returns execution results to the distributed computing server 5. This transfer of data is repeated until the end date of a non-use time (S109).

In the client 2, the arrival of the end date of the non-use time indicated in the schedule data stored in the schedule storage block 24 is monitored (S110) and, when the end date arrives, an information processing log in the program execution block 20 is transmitted to the distributed computing server 5 (S111). Further, the distributed computing server 5 returns acknowledgement of the reception (ack) (S112).

Subsequently, in the client 2, schedule data is read from the schedule storage block 24 and the start date of a next non-use time is obtained. Then, the obtained date is stored in the date storage block 12a of the timer 12 (S106) and the power to the client 2 is turned off (S107). Here, too, when the date stored in the date storage block 12a arrives and, if the power to the client 2 is on in S101, then, it is preferable not to turn off the power also in S107.

On the other hand, after the end of distributed computing, the distributed computing server 5 notifies the mediation server 4 of computation results including a time used for the information processing related with distributed computing by the client 2 (S113). In the mediation server 4, the value of earned points stored in the user database 40 is updated on the basis of the notified computation results (S114).

In the distributed computing system 1 described above, when a schedule is set in the client 2, the client 2 itself notifies the mediation server 4 of the start of the information processing related with distributed computing in accordance with that schedule. Consequently, more non-use time of each client computer can be allocated to distributed computing. Further, in the client 2, the power is turned on/off in accordance with the schedule data stored in the schedule storage block 24, so that the power dissipation can be saved. In addition, the security of the client 2 can be ensured as compared with a configuration in which the power to the client 2 is turned on from the mediation server 4 or the distributed computing server 5.

It should be noted that the present invention is not limited to the embodiment described above and therefore many variations may be made thereto. For example, computation resource quantities required for the future may be estimated and different point values (point values per unit participation time) may be allocated to the users participating in distributed computing for each time zone in accordance with the estimation result.

For the above-mentioned purpose, a transition of estimated value EM of a resource allowance subsequent to the current time is estimated as shown in FIG. 10. This can be easily obtained from the transition of past resource allowance M. Also, as shown in FIG. 11, as distributed computing data, the distributed server ID of the distributed computing server 5, the transition of a computation resource quantity required for distributed computing to be executed in the distributed computing server 5, and a reliability necessary for this distributed computing (a request reliability) may be stored by relating these items of data, thereby determining threshold TH for estimated value EM of a resource allowance on the basis of the request reliability and the total resource quantities necessary for distributed computing. The request reliability is indicative of a degree in which resource allowance M is not allowed to become zero. For example, if the request reliability is high, resource allowance M is not allowed to become zero, thereby pushing up threshold TH. If the request reliability is low, resource allowance M is allowed to become zero, thereby lowering threshold TH. For example, if the request reliability is 3 for the distributed computing executed by a certain distributed computing server 5, 30% of the computation resource quantity necessary for distributed computing is an individual threshold; if the request reliability is 2, 20% of the necessary computation resource quantity is an individual threshold; and, if the request reliability is 1, 10% of the necessary computation resource quantity is an individual threshold. Then, the individual thresholds computed for each distributed computing server 5 are added to get threshold TH.

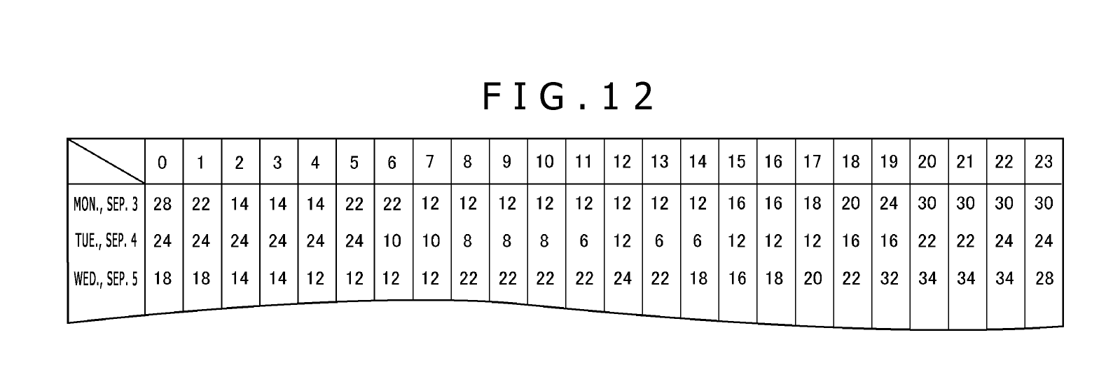

Next, on the basis of a difference between resource allowance estimated value EM and threshold TH, a point value to be allocated to the user per unit participation time is determined for each time zone. In other words, as a value obtained by subtracting threshold TH from resource allowance estimated value EM gets higher, a lower point value is allocated and, as the subtracted value gets smaller, a higher point value is allocated. Further, it is preferable that a point value for each time zone determined as described above is tabulated as shown in FIG. 12 as one example to be transmitted to the client 2. This configuration allows the user to judge which time zone to participate in distributed computing in order to earn many points by referring to this table. Then, users who want to participate in distributed computing in a time zone in which the difference between resource allowance estimated value EM and threshold TH is small can be increased.

1. A distributed computing system comprising:
a server computer; and
a plurality of client computers, said each client computer including
a schedule data storage section storing schedule data indicative of a time at which said client computer participates in distributed computing,
a request section requesting said server computer for data related with distributed computing in accordance with said schedule data, and
an information processing section receiving data transmitted in accordance with said request and executing information processing related with said distributed computing on the basis of the received data.

2. The distributed computing system according to claim 1, wherein
said each client computer controls a power to the client computer concerned in accordance with said schedule.

3. The distributed computing system according to claim 1, wherein
said each client computer transmits said schedule to said server computer.

4. The distributed computing system according to claim 3, wherein,
in receiving said request from said each client computer, if there is no information processing related with said distributed computing to be executed in said client computer, said server computer transmits, to said client computer, data indicative of date at which said client computer next transmits said request to said server computer on the basis of said schedule data.

5. The distributed computing system according to claim 1,
wherein
said server computer stores a point value in accordance with a time of said information processing in said each client computer by relating said point value with said client computer.

6. A client computer for distributed computing comprising:
a schedule data storage section storing schedule data indicative of a time at which said client computer participates in distributed computing;
a request section requesting said server computer for data related with distributed computing in accordance with said schedule data; and
an information processing section receiving data transmitted in accordance with said request and executing information processing related with said distributed computing on the basis of the received data.

7. A server computer for distributed computing comprising:
a schedule data reception section receiving, from a plurality of client computers for distributed computing, schedule data indicative of a time at which said client computer participates in distributed computing;
a request reception section receiving a request transmitted by said each client computer on the basis of said schedule data; and
a data transmission section, in receiving said request from said each client computer, if there is no information processing related with said distributed computing to be executed in said client computer, transmitting, to said client computer, data indicative of a date on which said client computer next transmits said request on the basis of said each piece of schedule data.

8. A distributed computing method comprising:
setting schedule data indicative of a time at which participation in distributed computing is done;
requesting a server computer for data related with distributed computing in accordance with said schedule data; and
receiving data transmitted in accordance with said request in order to execute information processing related with said distributed computing on the basis of the received data.

9. An information storage medium storing a program for a computer, the program comprising:
storing schedule data indicative of a time at which participation in distributed computing is done;
requesting said server computer for data related with distributed computing in accordance with said schedule data; and
receiving data transmitted in accordance with said request and executing information processing related with said distributed computing on the basis of the received data.
